(19) United States
(12) Patent Application Publication
(10) Pub. No.: US 2013/0271993 A1
(43) Pub. Date: Oct. 17, 2013

(54) Foldable lighting device with multiple panels

(71) Applicant: Johnny Jan, New Taipei City (TW)

(72) Inventor: Johnny Jan, New Taipei City (TW)

(21) Appl. No.: 13/448,369

(22) Filed: Apr. 16, 2012

(51) Int. Cl. F21V 21/30; F21V 29/00

(52) U.S. Cl. 362/249.09; 362/249.1

(57) ABSTRACT

A foldable lighting device includes a main panel and one or two side panels. A plurality of illuminants are provided on the main panel and the side panels. A pivot is provided to link the main panel with either side panel so that either side panel may be rotated with respect to the main panel to adjust the direction and brightness of illumination. As either side panel is rotated from the parallel position towards the main panel, the range of illumination becomes smaller and the light becomes more concentrated. As either side panel is rotated from the parallel position towards the back side of the main panel, the range of illumination becomes larger and the light becomes less concentrated.

### BACKGROUND OF THE INVENTION

1. Field of the invention

The invention generally relates to a lighting device. More particularly, the invention relates to a foldable lighting device that includes multiple panels and in which the range, direction and brightness of illumination may be adjusted so that the lighting device is easy to carry around and use.

2. Description of the prior art

Historically, lighting devices have been around for a long time. As the science and technologies advance, lighting devices have become brighter and brighter, but many of them have a shorter service life.

Lighting devices may be categorized into two types: fixed type and mobile type. Lighting devices of the fixed type are fixedly installed in a building for the purpose of illumination. Because they are fixedly installed and electricity may often be fed to them conveniently and plentifully, they may have different designs and sizes. On the other hand, because lighting devices of the mobile type need to be carried or moved around, they are more restricted in terms of design and size.

Conventionally, a lighting device only has a lighting panel. When a higher level of brightness or a wider range of illumination is needed, two or more lighting devices are needed.

In addition, if a certain amount of such lighting devices are not sufficient for illumination, a user would have to go back to get more or would have to get more from other place. Moreover, if the number of lighting devices is greater than the number of electric sockets, this may be problematic.

From the above, we can see that the lighting devices of the prior art have many disadvantages and need to be improved.

To eliminate these disadvantages, the inventor of the present invention has put a lot of effort into the subject and has successfully come up with the foldable lighting device of the present invention.

### SUMMARY OF THE INVENTION

An object of the present invention is to provide a foldable lighting device in which either side panel may be rotated with respect to the main panel to adjust the range, direction and brightness of illumination.

A second object of the present invention is to provide a foldable lighting device that is easy to carry, easy to use and suitable to be used in various types of places.

A third object of the present invention is to provide a foldable lighting device that is provided with heat-dissipating fins and in which brightness may be adjusted so that the foldable lighting device has a longer service life and rarely malfunctions.

To reach the objects, the foldable lighting device of the present invention is disclosed. The foldable lighting device of the present invention comprises a main panel and one or two side panels. A plurality of illuminants are provided on the main panel and the side panels. A pivot is provided to link the main panel with either side panel so that either side panel may be rotated with respect to the main panel to adjust the direction and brightness of illumination. As either side panel is rotated from the parallel position towards the main panel, the range of illumination becomes smaller and the light becomes more concentrated. As either side panel is rotated from the parallel position towards the back side of the main panel, the range of illumination becomes larger and the light becomes less concentrated. A plurality of heat-dissipating fins are provided on the back sides of the main panel and either side panel to dissipate the heat generated by the main panel and either side panel to ensure the suitable level of brightness and so that the device may be used continuously for a longer period. If necessary, a base portion may be optionally provided below the main panel and the angle of the main panel may be adjusted with respect to the base portion.

### BRIEF DESCRIPTION OF THE DRAWINGS

FIG. 1 is a perspective view of the foldable lighting device of the present invention.

FIG. 2 is a perspective view of the foldable lighting device provided with a base portion.

FIGS. 4A to 4E are five views showing how both side panels are rotated backwards with respect to the main panel in the foldable lighting device of the present invention.

FIG. 5 is a perspective view of the foldable lighting device provided with a vertical stand portion.

### DETAILED DESCRIPTION OF THE PREFERRED EMBODIMENT

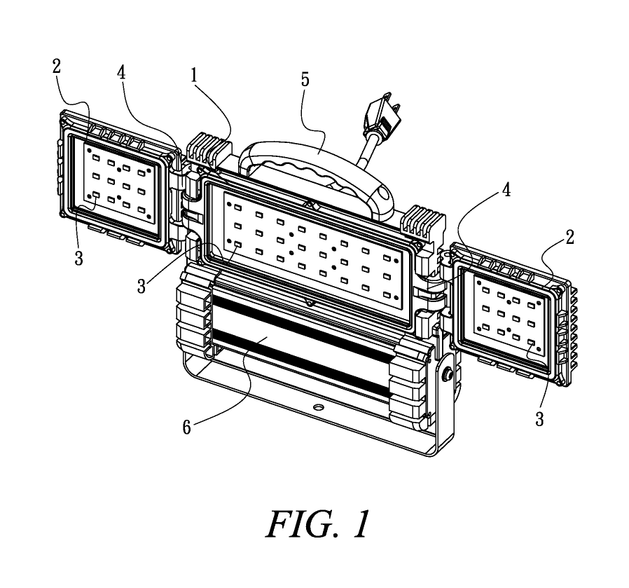

Please see FIGS. 1, 2 and 3 for the foldable lighting device of the present invention. The foldable lighting device of the present invention comprises a main panel 1 and one or two side panels 2. A plurality of illuminants 3 are provided on the main panel 1. The illuminants 3 may be the ordinary light bulbs or LED and may be lit up after power is switched on. One or two side panels 2 may be provided on one or two sides of the main panel 1. Similarly, a plurality of illuminants 3 are provided on either side panel 2 to provide illumination. A pivot 4 is provided to link the main panel 1 with either side panel 2 so that either side panel 2 may be rotated with respect to the main panel 1 to adjust the range, direction and brightness of illumination.

In addition, the sum of the lengths of the two side panels 2 should be smaller or equal to the length of the main panel 1 so that the one or two side panels 2 may be folded up onto the back side of the main panel 1 without sticking out of the main panel 1.

A control portion 6 is provided below the main panel 1 to control the main panel 1 and either side panel 2. Moreover, a handle 5 is provided above the main panel 1 to allow a user to carry the device around.

A plurality of heat-dissipating fins 9 are provided on the back sides of the main panel 1 and either side panel 2 to dissipate the heat generated by the main panel 1 and either side panel 2. Because the heat-dissipating fins 9 are provided on the back sides of the main panel 1 and either side panel 2, heat generated by the main panel 1 and either side panel 2 may still be dissipated when either side panel 2 is folded up onto the back side of the main panel 1.

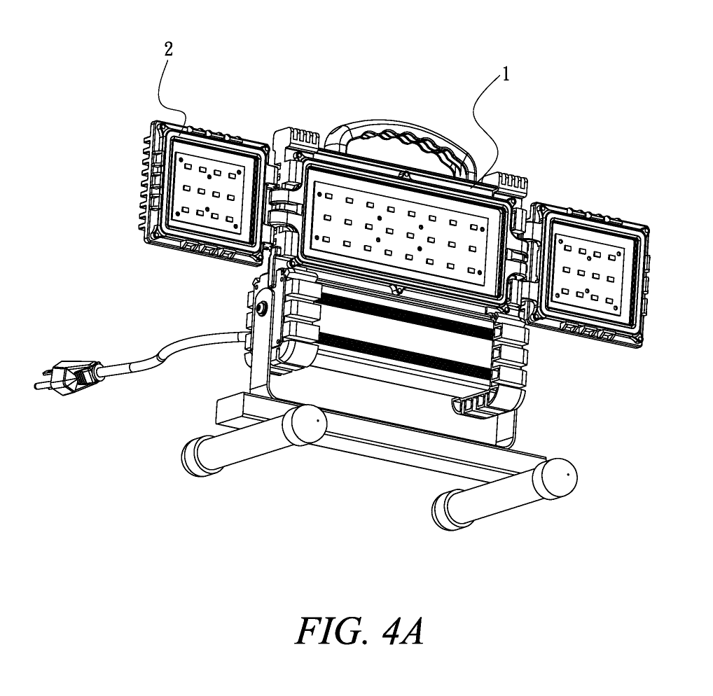

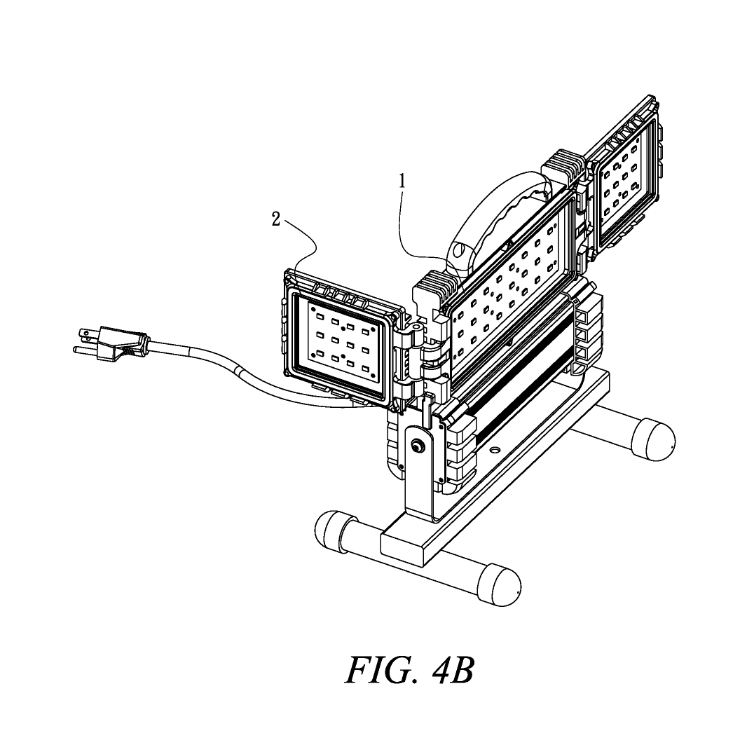

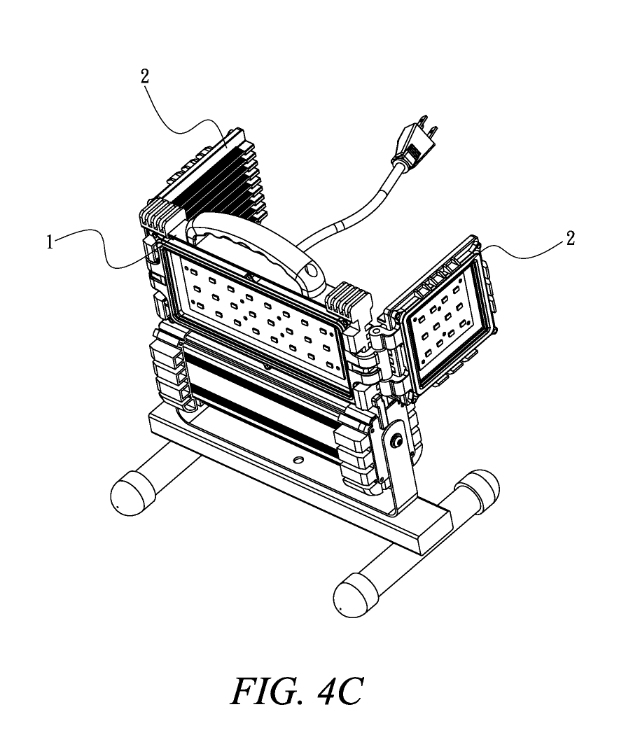

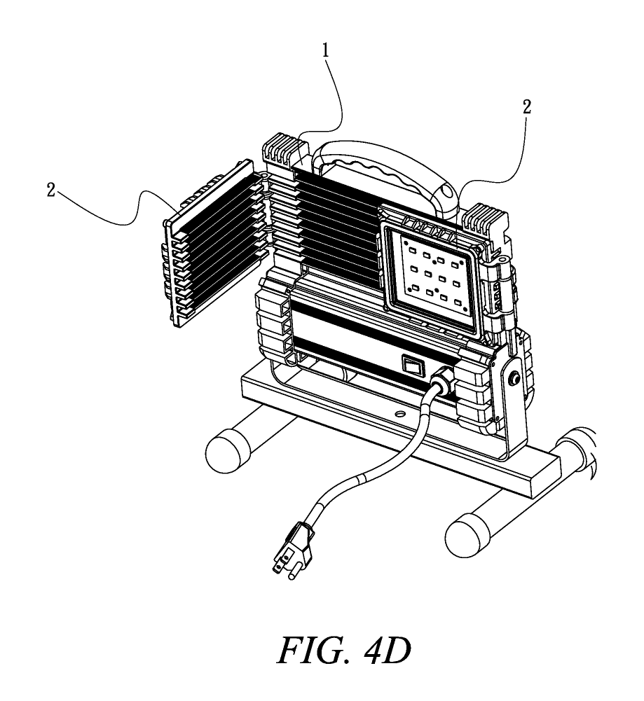

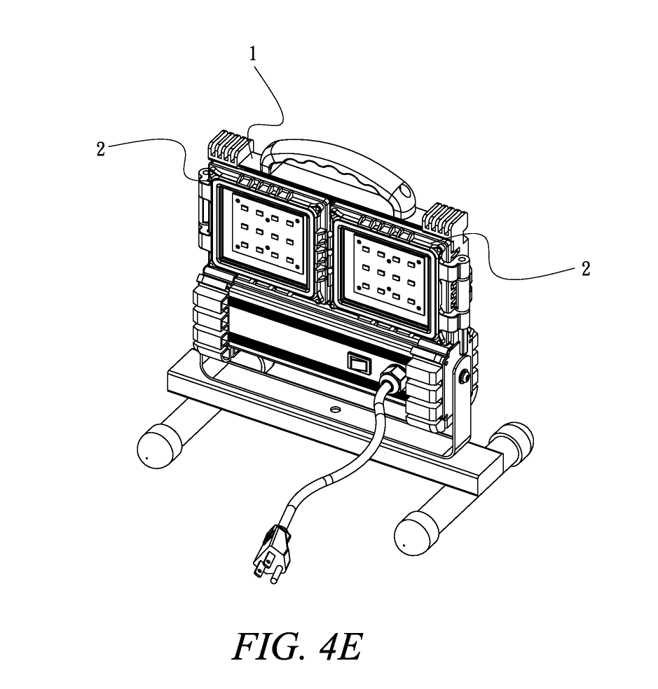

Therefore, either side panel 2 may be rotated with respect to the main panel 1 to adjust the angle of illumination. As illustrated in FIG. 4A, the two side panels 2 are in an unfolded position and hence can provide the maximum amount of light in the front direction. In FIG. 4B, a side panel 2 is rotated backwards by 90 degree with respect to the main panel 1 to provide illumination on the side of the main panel 1; therefore, less amount of light is provided in the front direction. In FIG. 4C, both side panels 2 are rotated backwards by 90 degree with respect to the main panel 1 to provide illumination on both sides of the main panel 1. In FIG. 4D, a side panel 2 is rotated backwards by 90 degree with respect to the main panel 1 and the other side panel 2 is rotated backwards by 180 degree with respect to the main panel 1 to provide illumination on the rear side of the main panel 1. In FIG. 4E, both side panels 2 are rotated backwards by 180 degree with respect to the main panel 1 to provide illumination in the front and rear directions with respect to the main panel 1.

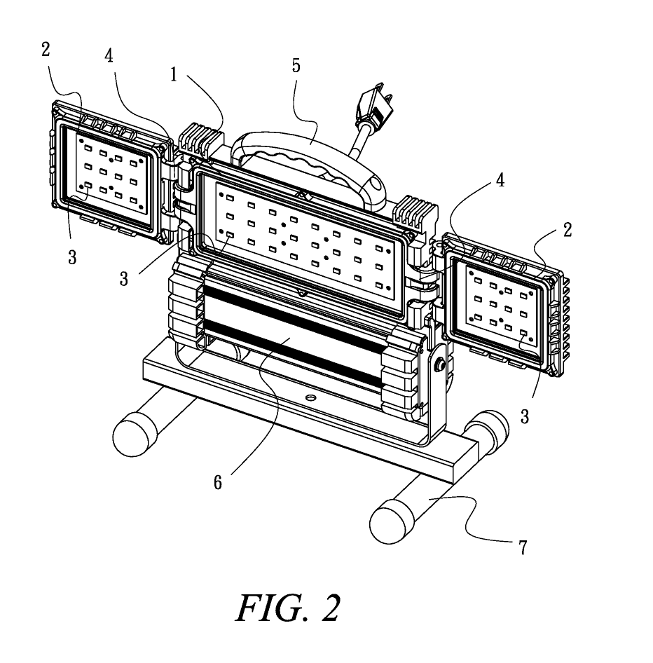

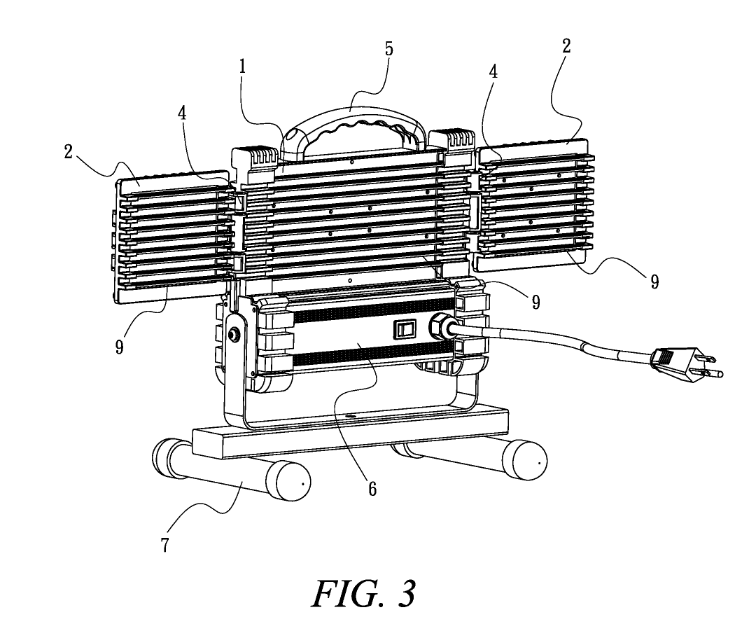

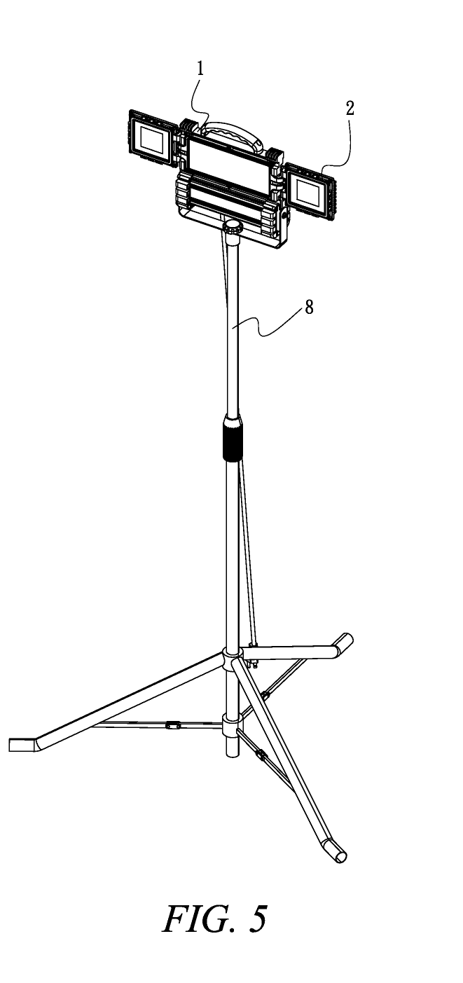

As illustrated in FIGS. 2 and 3, a base portion 7 may be optionally provided below the main panel 1 and the angle of the main panel 1 may be adjusted with respect to the base portion 7. As illustrated in FIG. 5, a longer vertical stand portion 8 may be connected under the main panel 1. The height of the longer vertical stand portion 8 may be adjusted so as to adjust the height of the illumination.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A foldable lighting device comprising:
a main panel, wherein a plurality of illuminants are provided on the main panel; and
two side panels, provided on two opposite sides of the main panel, wherein a plurality of illuminants are provided on each side panel,
wherein a pivot is provided to link the main panel with the side panel so that the two side panel may be rotated with respect to the main panel to adjust the direction and brightness of illumination, and after the two side panels are together folded onto a surface of the main panel, a total area of the two side panels is substantially matched with an area of the surface so that the main panel and the two side panels provide two opposite directions of illumination, respectively.

2. The foldable lighting device as in claim 1, wherein the two side panels may be rotated independently to provide illumination at different angles.

3. The foldable lighting device as in claim 1, wherein a plurality of heat-dissipating fins are provided on the back sides of the main panel and either side panel.

4. The foldable lighting device as in claim 1, wherein a control portion is provided below the main panel to control the main panel and the side panel.

5. The foldable lighting device as in claim 1, wherein a base portion may be provided below the main panel and the angle of the main panel may be adjusted with respect to the base portion.

6. The foldable lighting device as in claim 1, wherein a longer vertical stand portion may be connected under the main panel and the height of the longer vertical stand portion may be adjusted so as to adjust the height of the illumination.

7. The foldable lighting device as in claim 1, wherein a handle is provided above the main panel to allow a user to carry the device around.
